(19) United States
(12) Patent Application Publication
(10) Pub. No.: US 2024/0372642 A1
(43) Pub. Date: Nov. 7, 2024

(54) PROACTIVE JAMMER PROTECTION OF RECEIVER FROM TRANSMIT SIGNAL OF INTEGRATED TRANSMITTER

(71) Applicant: QUALCOMM Incorporated, San Diego, CA (US)

(72) Inventors: Harish VENKATACHARI, San Jose, CA (US); Ryan Scott Castro SPRING, San Diego, CA (US); Mandar KAKADE, San Diego, CA (US)

(21) Appl. No.: 18/313,224

(22) Filed: May 5, 2023

(51) Int. Cl. H04K 3/00

(52) U.S. Cl. CPC H04K 3/224

(57) ABSTRACT

An apparatus, including: a transmitter configured to generate a transmit radio frequency (RF) signal; a receiver configured to process a received RF signal, wherein the receiver comprises: a first filter; and a switching device coupled in parallel with the first filter; and a control circuit configured to control the switching device based on a concurrent transmission of the transmit RF signal and reception of the received RF signal.

### FIELD

Aspects of the present disclosure relate generally to receiver jammer protection, and in particular, to proactive jammer protection of a receiver from a transmit signal of an integrated transmitter.

### BACKGROUND

A transceiver includes a transmitter configured to transmit radio frequency (RF) signal and a receiver configured to receive a received RF signal. In some cases, the received RF signal includes out-of-band jammers, which are unwanted or non-target received RF signals that may interfere with the processing of the target received RF signal. For example, an out-of-band jammer may saturate or cause a low noise amplifier (LNA) of the receiver to operate in an undesirable linear region that results in distortion or a reduction in the signal-to-noise ratio (SNR) associated with the target received RF signal.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

An aspect of the disclosure relates to an apparatus. The apparatus includes: a transmitter configured to generate a transmit radio frequency (RF) signal; a receiver configured to process a received RF signal, wherein the receiver comprises: a first filter; and a switching device coupled across the first filter; and a control circuit configured to control the switching device based on a concurrent transmission of the transmit RF signal and reception of the received RF signal.

Another aspect of the disclosure relates to a method. The method includes scheduling a transmission of a transmit radio frequency (RF) signal concurrently with a reception of a received RF signal; and enabling or bypassing a filtering of the received RF signal during the concurrent transmission and reception of the transmit and received RF signals based on at least a characteristic of the transmit RF signal.

Another aspect of the disclosure relates to an apparatus. The apparatus includes means for scheduling a transmission of a transmit radio frequency (RF) signal concurrently with a reception of a received RF signal; and means for enabling or bypassing a filtering of the received RF signal during the concurrent transmission and reception of the transmit and received RF signals based on at least a characteristic of the transmit RF signal.

To the accomplishment of the foregoing and related ends, the one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the description implementations are intended to include all such aspects and their equivalents.

### BRIEF DESCRIPTION OF THE DRAWINGS

FIG. 1 illustrates a block diagram of an example transceiver in accordance with an aspect of the disclosure.

FIG. 2 illustrates a block diagram of another example transceiver in accordance with another aspect of the disclosure.

FIG. 3 illustrates a look-up-table (LUT) for determining jammer situations associated with concurrent signal transmission and reception operations of the example transceiver of FIG. 2 in accordance with another aspect of the disclosure.

FIG. 4 illustrates a flow diagram of an example method of enabling or bypassing a receiver filter to address out-of-band jammer situations associated with concurrent signal transmission and reception in accordance with another aspect of the disclosure.

FIG. 5 illustrates a block diagram of another example transceiver in accordance with another aspect of the disclosure.

FIG. 6 illustrates a block diagram of another example transceiver in accordance with another aspect of the disclosure.

FIG. 7 illustrates a flow diagram of an example method of modifying a look-up-table (LUT) for determining proactive out-of-band jammer situations associated with concurrent signal transmission and reception in accordance with another aspect of the disclosure.

FIG. 8 illustrates a block diagram of another example transceiver in accordance with another aspect of the disclosure.

FIG. 9 illustrates a block diagram of another example transceiver in accordance with another aspect of the disclosure.

FIG. 10 illustrates a block diagram of another example transceiver in accordance with another aspect of the disclosure.

FIG. 11 illustrates a flow diagram of an example method of enabling or bypassing a receiver filter in accordance with another aspect of the disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

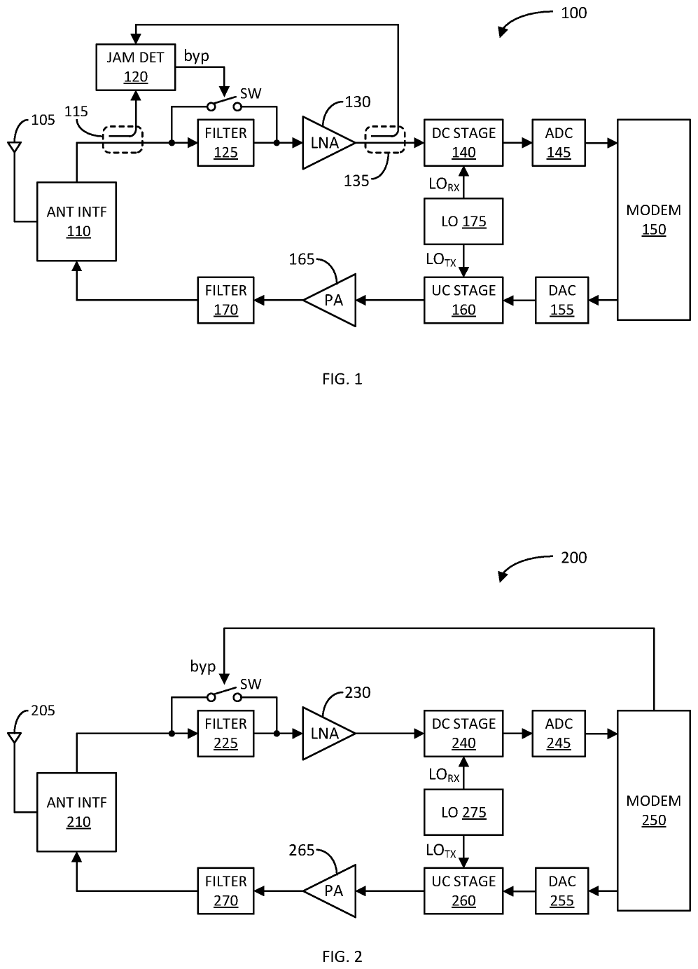

FIG. 1 illustrates a block diagram of an example transceiver 100 in accordance with an aspect of the disclosure. The transceiver 100 may be part of a user equipment (UE), such as a mobile device, smart phone, or other wireless communication device. The transceiver 100 includes a receiver including a first coupler 115, a jammer detector 120, a receive (Rx) filter 125 (e.g., an RF filter implemented as a surface acoustic wave (SAW) filter, bulk acoustic wave (BAW) filter, film bulk acoustic resonator (FBAR), or other), a switching device (SW), a low noise amplifier (LNA) 130, a second coupler 135, one or more frequency downconverting (DC) stages 140, and an analog-to-digital converter (ADC) 145.

The transceiver 100 further includes a transmitter including a digital-to-analog converter (DAC) 155, one or more frequency upconverting stages 160, a power amplifier (PA) 165, and a transmit (Tx) filter 170 (e.g., SAW, BAW, FBAR, or other). The transceiver 100 additionally includes components common to both the receiver and the transmitter, including at least one antenna 105 (e.g., an antenna array), an antenna interface 110 (e.g., a duplexer, diplexer, or other), one or more local oscillators (LO) 175, and a modem 150.

With regard to signal reception, the receiver of the transceiver 100 is configured to receive a radio frequency (RF) signal via the at least one antenna 105 and the antenna interface 110. The received RF signal may include an in-band or target RF signal and one or more out-of-band jammers. When enabled, the Rx filter 125 is configured to substantially reject the out-of-band jammers from the received RF signal while substantially passing through the in-band or target RF signal.

In this regard, the jammer detector 120 is configured to receive a sample of the received RF signal via the first coupler 115, detect the presence of one or more out-of-band jammers in the input RF signal, and operate the switching device (SW) via a bypass (byp) signal. The switching device (SW) is coupled in parallel with the Rx filter 125. For example, if the jammer detector 120 detects one or more out-of-band jammers in the received RF signal (e.g., by detecting an RF power level above a threshold), the jammer detector 120 does not assert the bypass signal so that bypass switching device (SW) is off or open, and the received RF signal is processed by the Rx filter 125 to substantially reject the one or more out-of-band jammers. If the jammer detector 120 does not detect an out-of-band jammer in the received RF signal, the jammer detector 120 asserts the bypass signal so that the bypass switching device (SW) is on or closed, and the received RF signal bypasses the Rx filter 125 so that the insertion loss of the Rx filter 125 does not affect the received RF signal.

The LNA 130 is configured to amplify the filtered or unfiltered received RF signal to generate an amplified RF signal. The jammer detector 120 may optionally determine whether the received RF signal includes one or more out-of-band jammers based on the signal-to-noise ratio (SNR) associated with the amplified RF signal at the output of the LNA 130. If one or more out-of-band jammers are present in the received RF signal, the signal-to-noise ratio (SNR) of the LNA amplified RF signal is typically low due to saturation or non-linear effects of the LNA 130 as a result of one or more out-of-band jammers. Conversely, if no out-of-band jammers is present in the received RF signal, the signal-to-noise ratio (SNR) of the LNA amplified RF signal is typically high due to more linear operation of the LNA 130.

Accordingly, in this regard, the jammer detector 120 is configured to receive a sample of the LNA amplified RF signal via the second coupler 135, determine the SNR of the LNA amplified RF signal, detect the presence of one or more out-of-band jammers in the received RF signal based on the SNR, and operate the switching device (SW) via the bypass signal. For example, if the jammer detector 120 detects one or more out-of-band jammers based on the SNR associated with the LNA amplified RF signal, the jammer detector 120 does not assert the bypass signal so that bypass switching device (SW) is off or open, and the received RF signal is processed by the Rx filter 125 to substantially reject the one or more out-of-band jammers. If the jammer detector 120 does not detect an out-of-band jammer based on the SNR associated with the LNA amplified RF signal, the jammer detector 120 asserts the bypass signal so that the bypass switching device (SW) is on or closed, and the received RF signal bypasses the Rx filter 125 so that the insertion loss of the Rx filter 125 does not affect the received RF signal.

The one or more downconverting stages 140 is configured to frequency downconvert the amplified RF signal using one or more local oscillator signals (LORX) generated by the one or more LOs 175 to generate a received analog baseband (BB) signal (e.g., direct to baseband (BB) or via an intermediate frequency (IF)). The ADC 145 is configured to convert the received BB signal from analog to digital, and provide the received digital BB signal to the modem 150 for further processing (e.g., recovering data from the received digital BB signal).

With regard to signal transmission, the modem 150 is configured to generate a transmit digital baseband (BB) signal. The DAC 155 is configured to convert the transmit digital baseband (BB) signal into a transmit analog BB signal. The one or more upconverting stages 160 is configured to frequency upconvert the transmit analog BB signal using one or more local oscillator signals (LO_{TX}) generated by the one or more LOs 175 to generate a transmit radio frequency (RF) signal (e.g., direct to RF or via an intermediate frequency (IF)). The power amplifier (PA) 165 is configured to amplify the transmit RF signal. The Tx filter 170 may perform spectrum mask filtering of the amplified transmit RF signal. The amplified/filtered RF signal is then routed to the at least one antenna 105 via the antenna interface 110 for wireless transmission.

With regard to jammer protection, some sources of out-of-band jammers include external sources, such as other wireless wide area network (WWAN) devices (e.g., UEs, base stations (BSs), etc.), wireless local area network (WLAN) devices (e.g., WiFi access points and user devices), personal area network (PAN) devices (e.g., Bluetooth, Zigbee devices), and others. Another source of out-of-band jammers is the integrated transmitter of the transceiver 100. For example, a portion of the amplified/filtered RF signal generated at the output of the Tx filter 170 and routed to the at least one antenna 105 via the antenna interface 110 may leak into the receiver of the transceiver 100. If the transmission of the transmit RF signal by the transmitter occurs concurrently or simultaneously with the reception of an RF signal by the receiver, the leaked transmit RF signal may constitute an out-of-band jammer for the receiver.

For example, in Evolved Universal Mobile Telecommunications System Terrestrial Radio Access Network (E-UTRAN) New Radio (NR) Dual Connectivity (e.g., also known as ENDC), the transceiver 100 may concurrently transmit a Long Term Evolution (LTE) RF signal while receiving a Fifth Generation New Radio (5G NR) RF signal, or vice-versa. Also, in a carrier aggregation (CA) scenario, the transceiver 100 may concurrently transmit an RF signal including a first carrier while receiving an RF signal including a second carrier. Similarly, in frequency division duplexing (FDD), the transceiver 100 may concurrently transmit an RF signal within a first frequency band while receiving an RF signal within a second frequency band.

In the aforementioned scenarios, there is a potential for the transmit RF signal leaking into the receiver to be deemed as an out-of-band jammer that may adversely affect the reception of the received RF signal by the receiver. In transceiver 100, the jammer detector 120, either by detecting the power level of the received RF signal via the first coupler 115 or the SNR of the amplified RF signal at the output of the LNA 130 via the second coupler 135, is able to enable the Rx filter 125 (e.g., by turning off the switching device (SW)) to reduce the adverse effects due to an out-of-band jammer, whether produced external to the transceiver 100 or by the integrated transmitter of the transceiver 100. However, in both cases, the dealing with out-of-band jammers is reactive. In other words, the jammer detector 120 has to first detect the out-of-band jammer, and then react to it by enabling the Rx filter 125. The delay in detection of the out-of-band jammer and enabling of the Rx filter 125 may be such that, in some cases, the received RF signal may be subjected to more noise/interference due to the jammer saturating the LNA 130, resulting in not successfully processing the received RF signal to recover data therefrom.

FIG. 2 illustrates a block diagram of another example transceiver 200 in accordance with another aspect of the disclosure. As discussed in more detail herein, the transceiver 200 proactively deals with out-of-band jammers coming from its own integrated transmitter by enabling the Rx filter concurrently or simultaneously with the transmitter transmitting an RF signal. Thus, instead of reactively dealing with its own transmitter's out-of-band jammer as in transceiver 100, the transceiver 200 proactively deploys the Rx filter when its transmitter is scheduled to transmit an RF signal that may potentially be an out-of-band jammer when the receiver is scheduled or likely to receive an RF signal.

In particular, the transceiver 200 includes a receiver including a receive (Rx) filter 225, a switching device (SW), a low noise amplifier (LNA) 230, one or more frequency downconverting stages 240, and an analog-to-digital converter (ADC) 245. The operations of these receiver components have been discussed in detail with reference to transceiver 100. The transceiver 200 further includes a transmitter including a digital-to-analog converter (DAC) 255, one or more frequency upconverting stages 260, a power amplifier (PA) 265, and a transmit (Tx) filter 270. Similarly, the operations of these transmitter components have been discussed in detail with reference to transceiver 100. Further, the transceiver 200 includes at least one antenna 205 (e.g., an antenna array), an antenna interface 210 (e.g., a duplexer, diplexer, or other), one or more local oscillators (LO) 275, and a modem 250. These transceiver components have also been discussed in detail with reference to transceiver 100.

To effectuate proactive enablement of the Rx filter 225 to deal with out-of-band jammers due to the transmitter's RF signal leaking into the receiver, the modem 250 (or other control circuitry associated with the transmitter and the receiver) is configured to generate the bypass signal for controlling the on/off state of the switching device SW, i.e., controlling the bypassing/enabling of the Rx filter 225. For example, the modem 250 may have scheduling information as to when the transceiver 200 is to receive an RF signal and to transmit an RF signal (e.g., a granted reception and transmission time slots). If the modem 250 determines that the transmission of an RF signal is scheduled to occur concurrently with the reception of an RF signal, the modem 250 (which may include a control circuit for controlling the switching device (SW) or which may send information or commands to a control circuit associated with the transmitter or receiver that controls the switching device (SW)) may deassert the bypass signal so that the switching device (SW) is off or open, and the Rx filter 225 is enabled during the scheduled time interval of the concurrent transmission and reception of RF signals, respectively. Conversely, if the modem 250 determines that the transmission of an RF signal is not scheduled during a scheduled reception an RF signal, the modem 250 may assert the bypass signal so that the switching device (SW) is on or closed, and the Rx filter 225 is bypassed so that the insertion loss of the Rx filter 225 does not affect the reception of the RF signal. As discussed further herein, the transceiver 200 may also include a jammer detector for detecting out-of-band jammers as per transceiver 100.

Further, even if the modem 250 determines that the transmission and reception of RF signals are scheduled to occur concurrently, the modem 250 may continue to assert the bypass signal to maintain the switching device (SW) on or closed and the Rx filter 225 bypassed if the transmit RF signal, leaked into the receiver as an out-of-band jammer, may not adversely affect the reception of an RF signal by the receiver. This may be the case where the transmit RF signal is far away in frequency from the received RF signal that the operating bandwidth of the LNA 230 would substantially reject the leaked transmit RF signal. Or the power level of the transmit RF signal is relatively low that it would not adversely affect the processing of the received RF signal by the receiver.

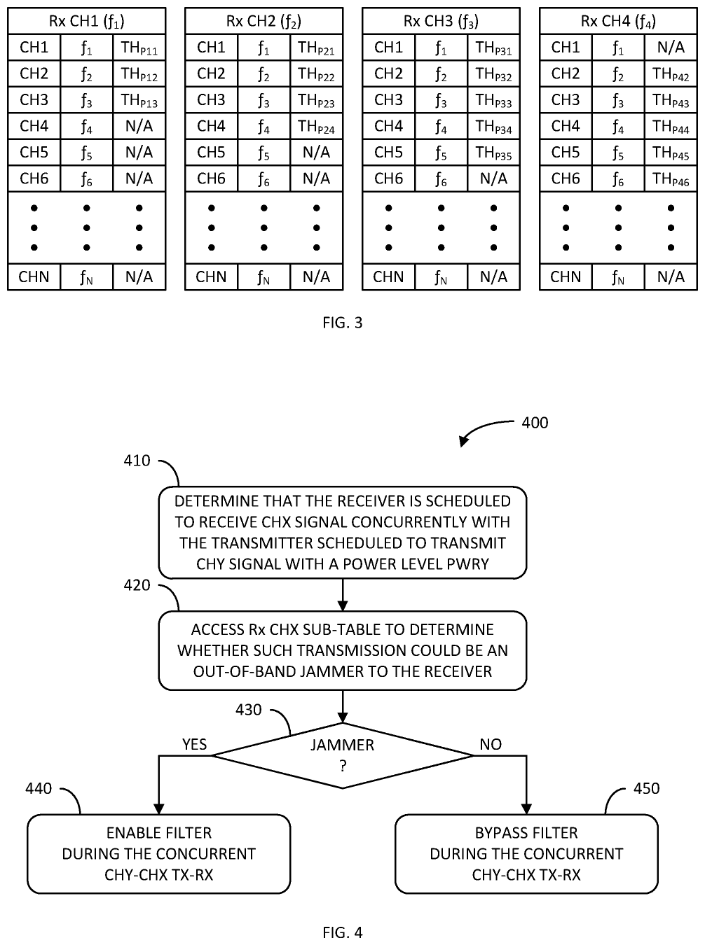

FIG. 3 illustrates a look-up-table (LUT) for determining potential out-of-band jammer situations associated with concurrent signal transmission and reception operations of the example transceiver 200 in accordance with another aspect of the disclosure. The LUT may reside in the modem 250, and used by its switching device control circuit, for determining how to control the switching device (SW) via the bypass control signal. As discussed above, the frequency and power level of the transmit RF signal may be factors considered in enabling or bypassing the Rx filter 225 when concurrent signal transmission and reception is to occur.

As previously mentioned, if the difference in frequencies between the transmit RF signal of the received RF signal is significantly large (or some other harmonic relationship between the frequencies does not result in an adverse out-of-band jammer situation), then an adverse out-of-band jammer situation may not be present even if the transmission of the transmit RF signal occurs concurrently with the reception of the received RF signal. In such case, the modem 250 (via a turned-on switching device (SW)) bypasses the Rx filter 225 so as not to affect the received RF signal. Conversely, if the difference in frequencies between the transmit RF signal and the received RF signal is relatively small (or there is some harmonic relationship between the frequencies that would result in an adverse out-of-jammer situation), then an adverse out-of-band jammer situation may exist. In such case, the modem 250 enables the Rx filter 225 (via a turned-off switching device (SW)) to substantially reject the out-of-band jammer.

Similarly, if the power level of the transmit RF signal is relatively low, then an adverse out-of-band jammer situation may not be present even if the transmission of the transmit RF signal occurs concurrently with the reception of a received RF signal, and the difference in frequencies between the transmit and received RF signals is relatively small. In such case, the modem 250 bypasses the Rx filter 225 (via a turned-on switching device (SW)) so as not to affect the received RF signal. Conversely, if the power level of the transmit RF signal is relatively high, then an adverse out-of-band jammer situation may exist. In such case, the modem 250 enables the Rx filter 225 (via a turned-off switching device (SW)) to substantially reject the out-of-band jammer.

In this regard, the LUT may be three-dimensional (3D) with inputs including the frequency or channel of the received RF signal, the frequency or channel of the transmit RF signal, and the power level of the transmit RF signal. To illustrate the 3D LUT, the LUT includes a set of sub-tables pertaining to a set of channels CH1-CH4 with center frequencies f₁-f₄ by which an RF signal may be received, respectively. Although, in this example, the number of received channels is four (4), it shall be understood that the number of channels may be different. Each of the sub-tables includes left- and middle-columns indicating a set of channels CH1-CHN with center frequencies f₁-f_{N} by which an RF signal is transmitted, respectively. Each of the sub-tables also includes a right-column indicating a set of power level thresholds or not applicable (N/A) pertaining to a transmit RF signal, respectively.

Considering a couple of examples, if the modem 250 determines that the transceiver 200 is scheduled to concurrently receive an RF signal in CH1 and transmit an RF signal in CH2 with a power level P₁, the modem 250 consults the sub-table pertaining to received CH1 RF signal to determine whether the power level P₁ is greater than the corresponding power level threshold TH_{P12}. If the power level P₁ is greater than the power level threshold TH_{P12}, the modem 250 then deasserts the bypass signal during the concurrent signal transmission-reception interval to enable the Rx filter 225 to deal with the potential out-of-band jammer due to the transmit RF signal in CH2. This may be because the difference in frequencies between the transmit and receive channels CH2 and CH1 is relatively small and the power level P₁ is sufficiently high that an out-of-band jammer situation exists. If, on the other hand, the power level P₁ is less than the power level threshold TH_{P12}, the modem 250 may maintain the bypass signal asserted during the concurrent signal transmission-reception interval to bypass the Rx filter 225 so as to not adversely affect the received RF signal.

If the modem 250 determines that the transceiver 200 is scheduled to concurrently receive an RF signal in CH3 and transmit an RF signal in CH6 with a power level P₂, the modem 250 consults the sub-table pertaining to received CH3 RF signal to determine whether the transmit RF signal poses an out-of-band jammer situation. In this example, the corresponding power level entry is indicated as N/A, which means that the difference in the frequency f₆ of the transmit RF signal in CH6 is sufficiently large compared to the frequency f₃ of the received RF signal in CH3 that it does not create an out-of-band jammer situation for the receiver regardless of the transmit power level. In such case, the modem 250 maintains the bypass signal asserted during the concurrent signal transmission-reception interval to bypass the Rx filter 225 so as to not adversely affect the received RF signal.

FIG. 4 illustrates a flow diagram of an example method 400 of enabling or bypassing a receive (Rx) filter to address jammer situations associated with concurrent signal transmission and reception in accordance with another aspect of the disclosure. The method 400 may be implemented by the modem 250 (e.g., or control circuit therein) of transceiver 200.

According to the method 400, the modem 250 determines that the receiver is scheduled to receive a CHX signal (e.g., where “X” represents a number and/or letter identifying the received channel) concurrently with the transmitter scheduled to transmit a CHY signal (e.g., where “Y” represents a number and/or letter identifying the transmit channel) (block 410). The method 400 further includes the modem 250 accessing the corresponding receive channel CHY sub-table to determine whether the CHY transmission (e.g., with a particular frequency and transmit power level) could be an out-of-band jammer to the receiver (block 420).

If, in accordance with the method 400, the modem 250 determines that the CHY transmission could be an out-of-band jammer to the receiver (block 430), the modem 250 enables the Rx filter 225 (e.g., by deasserting the bypass signal so that the switching device (SW) is off or open) during the concurrent transmission of the CHY transmit RF signal and reception of the CHX received RF signal (block 440). If, on the other hand, the modem 250 determines that the CHY transmission would not be an out-of-band jammer to the receiver in block 430, the modem 250 bypasses the Rx filter 225 (e.g., by asserting the bypass signal so that the switching device (SW) is on or closed) during the concurrent transmission of the CHY transmit RF signal and reception of the CHX received RF signal (block 450).

FIG. 5 illustrates a block diagram of another example transceiver 500 in accordance with another aspect of the disclosure. The transceiver 500 may be a variant of transceiver 200. In particular, the transceiver 500 implements both reactive and proactive manners of dealing with out-of-band jammers.

In particular, the transceiver 500 includes a receiver including a first coupler 515, a jammer detector 520, a receive (Rx) filter 525, a switching device (SW), a low noise amplifier (LNA) 530, one or more frequency downconverting stages 540, and an analog-to-digital converter (ADC) 545. The operations of these receiver components have been discussed in detail with reference to transceivers 100 and 200. The transceiver 500 further includes a transmitter including a digital-to-analog converter (DAC) 555, one or more frequency upconverting stages 560, a power amplifier (PA) 565, and a transmit (Tx) filter 570. Similarly, the operations of these transmitter components have been discussed in detail with reference to transceiver 100. Further, the transceiver 500 includes at least one antenna 505 (e.g., an antenna array), an antenna interface 510 (e.g., a duplexer, diplexer, or other), one or more local oscillators (LO) 575, and a modem 550. These transceiver components have also been discussed in detail with reference to transceiver 100.

As discussed, the transceiver 500 implements both reactive and proactive manners in dealing with out-of-band jammers. For example, when the source of an out-of-band jammer is external to the transceiver 500, the jammer detector 520 reacts to the out-of-band jammer by detecting the jammer based on a sample of an input RF signal received via the first coupler 515 and/or based on the SNR of the amplified RF signal at the output of the LNA 130, whose sample is received by the jammer detector 520 via the second coupler 535. Thus, if the jammer detector 520 detects an out-of-band jammer per any of the aforementioned methods, the jammer detector 520 deasserts the bypass signal to turn off or open the switching device (SW) to enable the Rx filter 525 so that it substantially rejects the out-of-band jammer. If the jammer detector 520 does not detect an out-of-band jammer per any of the aforementioned methods, the jammer detector 520 asserts the bypass signal to turn on or close the switching device (SW) to bypass the Rx filter 525 so that it does not adversely affect the received RF signal.

Further, if the modem 550 determines that the transmission of a transmit RF signal by the transmitter is scheduled to be concurrent with the reception of a received RF signal by the receiver, and the characteristics of the transmit RF signal (e.g., transmit power level, and frequency with respect to the frequency of the received RF signal) are such that the transmit RF signal leaking into the receiver may pose an out-of-band jammer situation, the modem 550 may deassert the bypass signal (e.g., by controlling the jammer detector 520 or independent of the jammer detector 520) to turn off or open the switching device (SW) to enable the Rx filter 525 during the concurrent transmission-reception interval so that it substantially rejects the out-of-band jammer. Otherwise, the modem 550 may abstain from controlling the bypass signal, and allow the jammer detector 520 to control the enabling or bypassing of the Rx filter 525 during the concurrent transmission-reception interval to reactively detect out-of-band jammers as previously discussed.

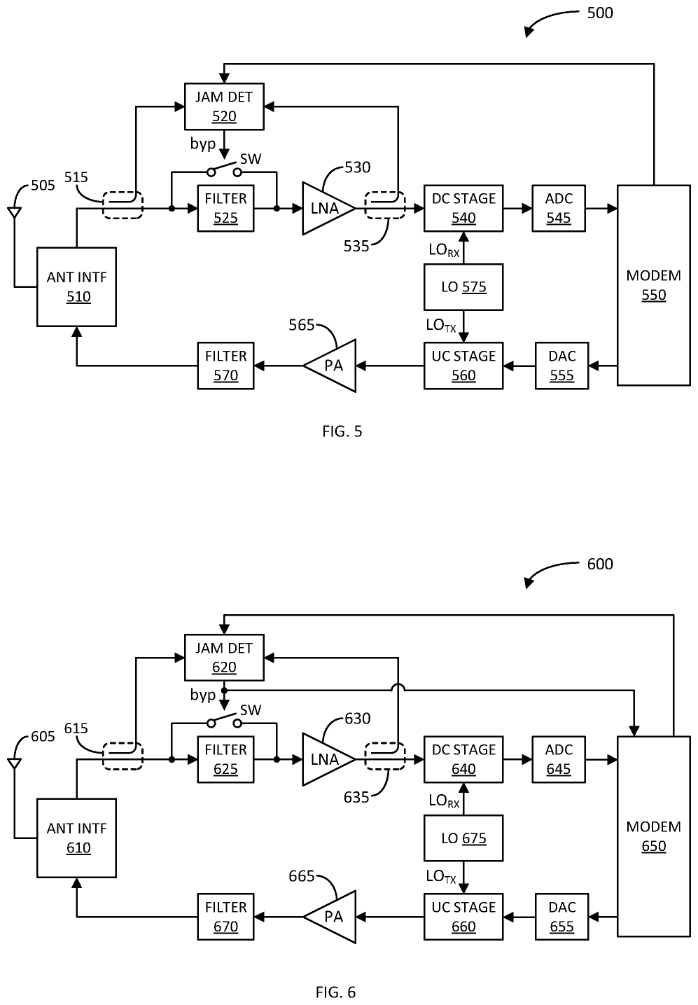

FIG. 6 illustrates a block diagram of another example transceiver 600 in accordance with another aspect of the disclosure. The transceiver 600 may be a variant of transceiver 500 previously discussed. With regard to transceiver 200, the LUT described with reference to FIG. 3 may not necessarily be static, but may be dynamic or adaptive to be modified while the transceiver 600 is in use in the field. Accordingly, as discussed in more detail, the jammer detector bypass signal may be provided to the modem for the purpose of dynamically or adaptively modifying what constitutes a proactive out-of-band jammer situation as indicated by the LUT.

In particular, the transceiver 600 includes a receiver including a first coupler 615, a jammer detector 620, a receive (Rx) filter 625, a switching device (SW), a low noise amplifier (LNA) 630, one or more frequency downconverting stages 640, and an analog-to-digital converter (ADC) 645. The operations of these receiver components have been discussed in detail with reference to transceivers 100, 200, and 500. The transceiver 600 further includes a transmitter including a digital-to-analog converter (DAC) 655, one or more frequency upconverting stages 660, a power amplifier (PA) 665, and a transmit (Tx) filter 670. Similarly, the operations of these transmitter components have been discussed in detail with reference to transceiver 100. Further, the transceiver 600 includes at least one antenna 605 (e.g., an antenna array), an antenna interface 610 (e.g., a duplexer, diplexer, or other), one or more local oscillators (LO) 675, and a modem 650. These transceiver components have also been discussed in detail with reference to transceivers 100 and 500.

The transceiver 600 further includes a feedback of the bypass signal generated by the jammer detector 620 to the modem 650. The modem 650 may use the bypass signal to modify the LUT dynamically or adaptively for identifying proactive out-of-band jammer situations. Considering some examples, the LUT in the modem 650 may not be populated or populated with default factory information for identifying proactive out-of-band jammer situations. During field operations, the modem 650 may temporarily forego or suspend controlling the bypass switching device (SW) (e.g., for a certain period from leaving the factory, periodically, or other time-basis), and allow the jammer detector 620 to identify out-of-band jammers associated with concurrent signal transmission and reception intervals.

Based on the received signal channel (frequency), the transmit signal channel (frequency), the transmit power level, and the bypass signal received from the jammer detector 520, the modem 550 may modify the LUT to reflect whether or not that concurrent transmission-reception profile constitutes a proactive out-of-band jammer situation. For example, if the bypass signal is not asserted, then the modem 550 may modify the LUT entry associated with that concurrent transmission-reception profile to set the corresponding power level threshold to the transmit power level of the transmission-reception profile or lower. If the bypass signal is asserted, and the current LUT entry for the power level threshold is lower than the transmit power level of the concurrent transmission-reception profile, the modem 550 may increase the corresponding power level threshold indicated in the LUT. The modem 650 may perform the aforementioned operations to refine the LUT to better reflect in the field proactive out-of-band jammer metrics.

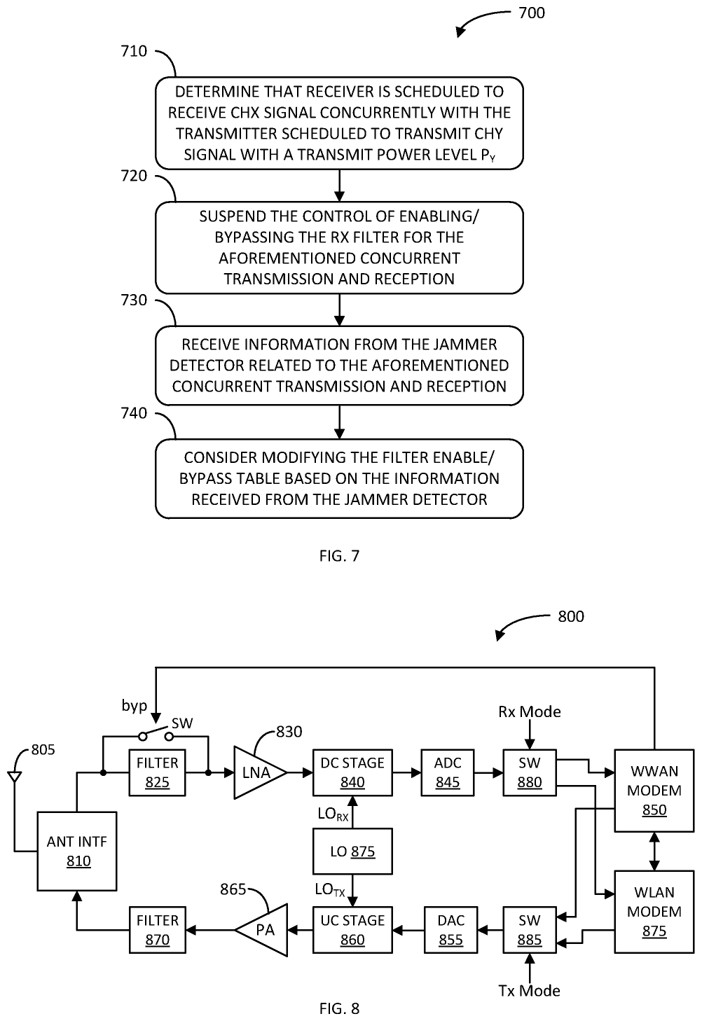

FIG. 7 illustrates a flow diagram of an example method 700 of modifying a look-up-table (LUT) for determining proactive out-of-band jammer situations associated with concurrent signal transmission and reception in accordance with another aspect of the disclosure.

The method 700 includes the modem 650 determining that the receiver is scheduled to receive CHX signal concurrently with the transmitter scheduled to transmit CHY signal with a transmit power level P_{Y} (block 710). Additionally, the method 700 includes the modem 650 suspending the control of enabling/bypassing the Rx filter 625 for the aforementioned concurrent transmission and reception interval (block 720). Further, the method 700 includes the modem 650 receiving information (e.g., the bypass signal) from the jammer detector 620 related to the aforementioned concurrent transmission and reception (block 730). Also, the method 700 includes the modem 650 considering modifying the filter enable/bypass LUT based on the information received the jammer detector 620 (block 740).

FIG. 8 illustrates a block diagram of another example transceiver 800 in accordance with another aspect of the disclosure. The transceiver 800 may be a variant of the transceiver 200 previously discussed. The transceiver 800 may include two (or more) modems for the transmission/reception of signals pursuant to two (or more) different protocols, respectively. For example, one of the modems may pertain to WWAN (e.g., LTE, NR, etc.) signal transmission/reception, and the other modem may pertain to WLAN (e.g., WiFi) signal transmission/reception.

In particular, the transceiver 800 includes a receiver including a receive (Rx) filter 825, a first switching device (SW), a low noise amplifier (LNA) 830, one or more frequency downconverting stages 840, and an analog-to-digital converter (ADC) 845. The operations of these receiver components have been discussed in detail with reference to transceivers 100 and 200. The receiver may further include a second switching device (SW) 880, which may be implemented as a single pole double throw (SPDT) type switching device.

The transceiver 800 further includes a transmitter including a digital-to-analog converter (DAC) 855, one or more frequency upconverting stages 860, a power amplifier (PA) 865, and a transmit (Tx) filter 870. Similarly, the operations of these transmitter components have been discussed in detail with reference to transceiver 100. The transmitter may further include a third switching device (SW) 885, which may also be implemented as a SPDT type switching device.

Further, the transceiver 800 includes at least one antenna 805 (e.g., an antenna array), an antenna interface 810 (e.g., a duplexer, diplexer, or other), and one or more local oscillators (LO) 875. These transceiver components have also been discussed in detail with reference to transceiver 100. Additionally, the transceiver 800 includes a WWAN modem 850 and a WLAN modem 875.

In this implementation, the second switching device (SW) 880 includes a pole coupled to the output of the ADC 845, a first throw coupled to an input of the WWAN modem 850, and a second throw coupled to an input of the WLAN modem 875. The second switching device (SW) 880 includes a control input configured to receive a receive (Rx) mode signal. Similarly, the third switching device (SW) 885 includes a first throw coupled to an output of the WWAN modem 850, a second throw coupled to an output of the WLAN modem 875, and a pole coupled to the input of the DAC 885. The third switching device (SW) 885 includes a control input configured to receive a transmit (Tx) mode signal.

The transceiver 800 may operate concurrently in accordance with WWAN and WLAN protocols. For example, the transceiver 800 may receive a WWAN signal concurrently with the transmission of a WLAN signal. In this case, the Rx mode signal controls the second switching device (SW) 880 to couple the pole to the first throw so that the WWAN signal processed by the receiver is routed to the WWAN modem 850 for further data recovery process; and the Tx mode signal controls the third switching device (SW) 885 to couple the second throw to the pole so that the WLAN signal generated by the WLAN modem 875 is processed by the transmitter for wireless transmission.

Similarly, the transceiver 800 may receive a WLAN signal concurrently with the transmission of a WWAN signal. In this case, the Rx mode signal controls the second switching device (SW) 880 to couple the pole to the second throw so that the WLAN signal processed by the receiver is routed to the WLAN modem 875 for further data recovery process; and the Tx mode signal controls the third switching device (SW) 885 to couple the first throw to the pole so that the WWAN signal generated by the WWAN modem 850 is processed by the transmitter for wireless transmission.

As the WWAN modem 850 has the scheduling information regarding reception and transmission of WWAN signals, and the WLAN modem 875 has the scheduling information regarding reception and transmission of WLAN signals, the modems 850 and 875 may communicate with each other (e.g., via a universal asynchronous receiver/transmitter (UART) or other communication link) to exchange information regarding concurrent transmission and reception for the purpose of proactively dealing with out-of-band jammers as previously discussed. For example, a similar Rx filter enable/bypass LUT, as described with reference to FIG. 3, may reside in the WWAN modem 850 (e.g., or in the WLAN modem 875), and the WWAN modem 850 may control the first switching device (SW) via the bypass signal based on whether a concurrent WWAN/WLAN signal transmission and reception may pose an out-of-band jammer for the receiver (e.g., based on the transmit signal channel/frequency with respect to the receive signal channel/frequency, and the transmit power level, as previously discussed).

Although in the example transceiver 800, the WWAN and WLAN signals share the same receive chain (e.g., filter 825, first switching device SW, LNA 830, DC stage 840, ADC 845) and transmit chain (e.g., DAC 855, UC stage 860, PA 865, and filter 870), it shall be understood that the WWAN and WLAN signals may be processed via their own receive and/or transmit chains. In such case, the switching devices 880 and/or 885 may not be needed. In such implementation, the WWAN modem 850 and WLAN modem 875 may cooperate to control the first switching device (SW) via the bypass signal based on whether a concurrent WWAN/WLAN signal transmission and reception may pose an out-of-band jammer for the receiver of either the WWAN or WLAN.

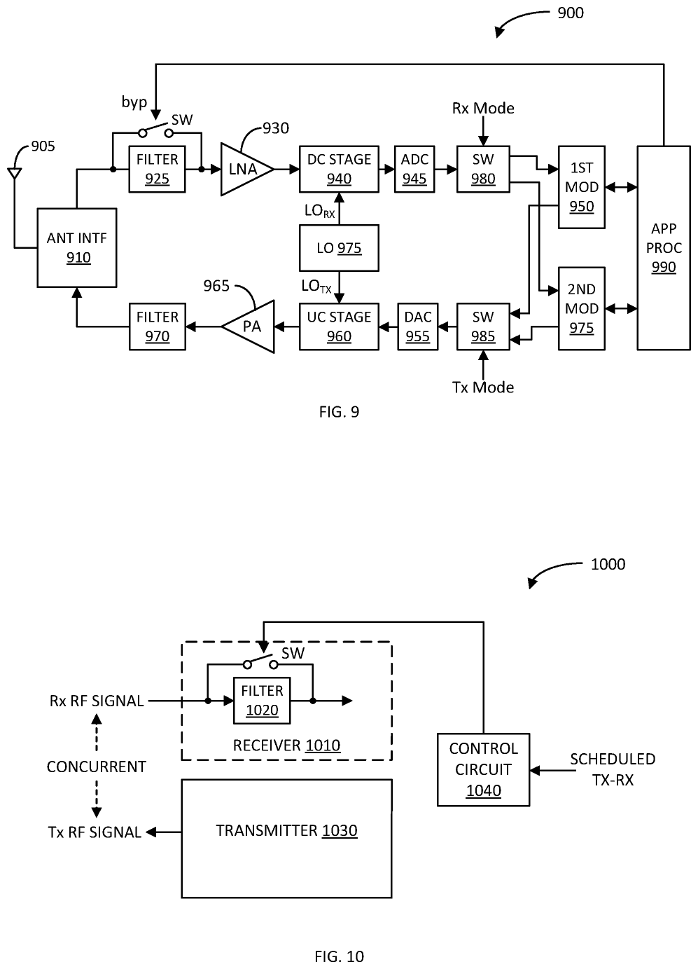

FIG. 9 illustrates a block diagram of another example transceiver 900 in accordance with another aspect of the disclosure. The transceiver 900 may be a variant of transceiver 800 previously discussed. In the previous transceivers 200, 500, 600, and 800, their respective modems controlled the Rx filter bypass switching device (SW) based on concurrent signal transmission and reception that may pose an out-of-band jammer situation for the corresponding receiver. However, it shall be understood that the control circuit for the Rx filter bypass switching device (SW) may reside elsewhere, such as in an application processor. In general, a transceiver may include a Rx filter bypass control circuit for concurrent signal transmission and reception scenarios, which may be separate or embedded in any component of the transceiver.

In particular, the transceiver 900 includes a receiver including a receive (Rx) filter 925, a first switching device (SW), a low noise amplifier (LNA) 930, one or more frequency downconverting stages 940, an analog-to-digital converter (ADC) 945, and a second switching device (SW) 980 (e.g., SPDT type switching device). The operations of these receiver components have been discussed in detail with reference to transceivers 100, 200, and 800. The transceiver 900 further includes a transmitter including a third switching device (SW) 985 (e.g., SPDT type switching device), a digital-to-analog converter (DAC) 955, one or more frequency upconverting stages 960, a power amplifier (PA) 965, and a transmit (Tx) filter 970. Similarly, the operations of these transmitter components have been discussed in detail with reference to transceivers 100 and 800.

Further, the transceiver 900 includes at least one antenna 905 (e.g., an antenna array), an antenna interface 910 (e.g., a duplexer, diplexer, or other), one or more local oscillators (LO) 975, a first modem 950 (e.g., a WWAN modem), and a second modem 975 (e.g., a WLAN modem). These transceiver components have also been discussed in detail with reference to transceivers 100 and 800.

The transceiver 900 further includes an application processor 990 configured to run user applications. The application processor 990 includes a first port coupled to the first modem 950 for receiving a data signal therefrom and providing a data signal thereto. Additionally, the application processor 990 includes a second port coupled to the second modem 975 for receiving a data signal therefrom and providing a data signal thereto. The application processor 990 may include a Rx filter enable/bypass look-up-table (LUT) as discussed with reference to FIG. 3 for controlling the Rx filter bypass switching device (SW) via the bypass signal based on concurrent signal transmission and reception that may pose an out-of-band jammer situation for the receiver, as previously discussed in detail.

FIG. 10 illustrates a block diagram of another example apparatus (e.g., a transceiver) 1000 in accordance with another aspect of the disclosure. The apparatus 1000 includes a transmitter 1030 configured to generate a transmit radio frequency (RF) signal. The apparatus 1000 further includes a receiver 1010 configured to process a received RF signal. The receiver 1010, in turn, includes a filter 1020 and a switching device (SW). Additionally, the apparatus 1000 includes a control circuit 1040 configured to control the switching device (SW) based on a scheduled concurrent transmission of the transmit RF signal and reception of the received RF signal.

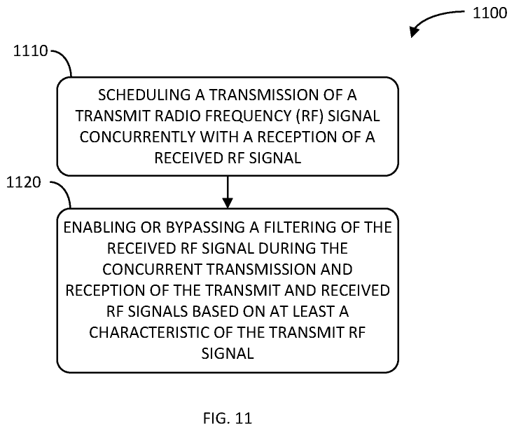

FIG. 11 illustrates a flow diagram of an example of method 1100 of deploying or bypassing a receiver filter in accordance with another aspect of the disclosure. The method 1100 comprises scheduling a transmission of a transmit radio frequency (RF) signal concurrently with a reception of a received RF signal (block 1110). Examples of means for scheduling a transmission of a transmit radio frequency (RF) signal concurrently with a reception of a received RF signal include any of the modems 250, 550, 650, 850, application processor 990, and control circuit 1040.

The method 1100 further comprises enabling or bypassing a filtering of the received RF signal during the concurrent transmission and reception of the transmit and received RF signals based on at least a characteristic of the transmit RF signal (block 1120). Examples of means for enabling or bypassing the filtering of the received RF signal during the concurrent transmission and reception of the transmit and received RF signals based on at least a characteristic of the transmit RF signal include any of the switching devices (SW) coupled in parallel with the corresponding receiver filters.

The following provides an overview of aspects of the present disclosure:

Aspect 1: An apparatus, comprising: a transmitter configured to generate a transmit radio frequency (RF) signal; a receiver configured to process a received RF signal, wherein the receiver comprises: a first filter; and a switching device coupled in parallel with the first filter; and a control circuit configured to control the switching device based on a concurrent transmission of the transmit RF signal and reception of the received RF signal.

Aspect 2: The apparatus of aspect 1, wherein the control circuit is configured to control the switching device based on a frequency of the transmit RF signal.

Aspect 3: The apparatus of aspect 1, wherein the control circuit is configured to control the switching device based on a first frequency of the transmit RF signal and a second frequency of the received RF signal.

Aspect 4: The apparatus of aspect 3, wherein the control circuit is configured to control the switching device based on a difference between the first and second frequencies.

Aspect 5: The apparatus of aspect 1, wherein the control circuit is configured to control the switching device based on a channel by which the transmit RF signal is transmitted.

Aspect 6: The apparatus of aspect 1, wherein the control circuit is configured to control the switching device based on a first channel by which the transmit RF signal is transmitted and a second channel by which the received RF signal is received.

Aspect 7: The apparatus of any one of aspects 1-6, wherein the control circuit is configured to control the switching device based on a power level of the transmit RF signal.

Aspect 8: The apparatus of any one of aspects 1-7, wherein at least one of the transmit RF signal or the received RF signal comprises a carrier aggregated signal.

Aspect 9: The apparatus of any one of aspects 1-8, wherein the transmit RF signal comprises a Long Term Evolution (LTE) transmit RF signal, and the received RF signal comprises a Fifth Generation New Radio (5G NR) signal.

Aspect 10: The apparatus of any one of aspects 1-9, wherein the receiver further comprises: a jammer detector configured to control the switching device based on detecting an out-of-band jammer in the received RF signal; and a coupler configured to produce a sample of the received RF signal, wherein the jammer detector is configured to control the switching device based on the sampled received RF signal.

Aspect 11: The apparatus of any one of aspects 1-10, wherein the receiver further comprises: a jammer detector configured to control the switching device based on detecting an out-of-band jammer in the received RF signal; and a low noise amplifier (LNA) configured to amplify the received RF signal, wherein the jammer detector is configured to control the switching device based on a signal-to-noise ratio (SNR) associated with the amplified received RF signal.

Aspect 12: The apparatus of any one of aspects 1-11, further comprising: a jammer detector configured to control the switching device based on detecting an out-of-band jammer in the received RF signal; a low noise amplifier (LNA) configured to amplify the received RF signal; and a coupler configured to produce a sample of the amplified received RF signal, wherein the jammer detector is configured to control the switching device based on the sampled amplified received RF signal.

Aspect 13: The apparatus of any one of aspects 1-12, wherein the control circuit includes a look-up-table (LUT) including information regarding different concurrent signal transmission and reception profiles, wherein the control circuit is configured to control the switching device based on the information related to the concurrent transmission of the transmit RF signal and the reception of the received RF signal accessed from the LUT.

Aspect 14: The apparatus of aspect 13, wherein: the receiver further comprises a jammer detector configured to control the switching device based on detecting an out-of-band jammer in the received RF signal.

Aspect 15: The apparatus of aspect 14, wherein the control circuit is configured to: suspend controlling the switching device during one or more other concurrent transmissions of transmit RF signals and receptions of received RF signals; and modify the LUT based on the jammer detector controlling the switching device during the one or more other concurrent transmissions of transmit RF signals and receptions of received RF signals.

Aspect 16: The apparatus of any one of aspects 1-15, further comprising a modem including the control circuit.

Aspect 17: The apparatus of any one of aspects 1-16, further comprising an application processor including the control circuit.

Aspect 18: The apparatus of any one of aspects 1-17, further comprising: a first modem configured to control the reception of the received RF signal in accordance with a first protocol; a second modem configured to control the transmission of the transmit RF signal in accordance with a second protocol; and a communication link coupling the first modem with the second modem, wherein the first or second modem includes the control circuit, and wherein the control circuit is configured to control the switching device based on information communicated between the first and second modems via the communication link.

Aspect 19: The apparatus of aspect 18, wherein the first or second protocol includes a wireless wide area network (WWAN) protocol, and the second or first protocol includes a wireless local area network (WLAN) protocol, respectively.

Aspect 20: The apparatus of aspect 1-19, further comprising: at least one antenna; an antenna interface, wherein the receiver is configured to receive the received RF signal via the at least one antenna and the antenna interface, wherein the receiver further comprises: a low noise amplifier (LNA) configured to amplify the received RF signal; one or more downconverting stages configured to frequency downconvert the received RF signal into a received analog baseband signal; and an analog-to-digital converter (ADC) configured to convert the received analog baseband signal into a received digital baseband signal; wherein the transmitter comprises: a digital-to-analog converter (DAC) configured to convert a transmit digital baseband signal into a transmit analog baseband signal; one or more upconverting stages configured to frequency upconvert the transmit analog baseband signal into an RF signal; a power amplifier (PA) and a second filter configured to respectively amplify and filter the RF signal to generate the transmit RF signal for wireless transmission via the antenna interface and the at least one antenna; and a modem configured to: process the received digital baseband signal; and generate the transmit digital baseband signal.

Aspect 21: The apparatus of any one of aspects 1-20, wherein the first filter comprises a radio frequency (RF) filter.

Aspect 22: A method, comprising: scheduling a transmission of a transmit radio frequency (RF) signal concurrently with a reception of a received RF signal; and enabling or bypassing a filtering of the received RF signal during the concurrent transmission and reception of the transmit and received RF signals based on at least a characteristic of the transmit RF signal.

Aspect 23: The method of aspect 22, wherein the characteristic of the transmit RF signal comprises a frequency of the transmit RF signal.

Aspect 24: The method of aspect 22 or 23, wherein the characteristic of the transmit RF signal comprises a channel by which the transmit RF signal is transmitted.

Aspect 25: The method of any one of aspects 22-24, wherein the characteristic of the transmit RF signal comprises a power level of the transmit RF signal.

Aspect 26: The method of any one of aspects 22-25, wherein the filtering or bypassing the filtering of the received RF signal is further based on a characteristic of the received RF signal.

Aspect 27: An apparatus, comprising: means for scheduling a transmission of a transmit radio frequency (RF) signal concurrently with a reception of a received RF signal; and means for enabling or bypassing a filtering of the received RF signal during the concurrent transmission and reception of the transmit and received RF signals based on at least a characteristic of the transmit RF signal.

Aspect 28: The apparatus of aspect 27, wherein the characteristic of the transmit RF signal comprises a frequency of the transmit RF signal.

Aspect 29: The apparatus of aspect 27 or 28, wherein the characteristic of the transmit RF signal comprises a channel by which the transmit RF signal is transmitted and/or a power level of the transmit RF signal.

Aspect 30: The apparatus of any one of aspects 27-29, wherein the means for enabling or bypassing the filtering of the received RF signal comprises means for enabling or bypassing the filtering of the received RF signal based on a characteristic of the received RF signal.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed:

1. An apparatus, comprising:
a transmitter configured to generate a transmit radio frequency (RF) signal;
a receiver configured to process a received RF signal, wherein the receiver comprises:
a first filter; and
a switching device coupled in parallel with the first filter; and
a control circuit configured to control the switching device based on a scheduled concurrent transmission of the transmit RF signal and reception of the received RF signal.

2. The apparatus of claim 1, wherein the control circuit is configured to control the switching device based on a frequency of the transmit RF signal.

3. The apparatus of claim 1, wherein the control circuit is configured to control the switching device based on a first frequency of the transmit RF signal and a second frequency of the received RF signal.

4. The apparatus of claim 3, wherein the control circuit is configured to control the switching device based on a difference between the first and second frequencies.

5. The apparatus of claim 1, wherein the control circuit is configured to control the switching device based on a channel by which the transmit RF signal is transmitted.

6. The apparatus of claim 1, wherein the control circuit is configured to control the switching device based on a first channel by which the transmit RF signal is transmitted and a second channel by which the received RF signal is received.

7. The apparatus of claim 1, wherein the control circuit is configured to control the switching device based on a power level of the transmit RF signal.

8. The apparatus of claim 1, wherein at least one of the transmit RF signal or the received RF signal comprises a carrier aggregated signal.

9. The apparatus of claim 1, wherein the transmit RF signal comprises a Long Term Evolution (LTE) transmit RF signal, and the received RF signal comprises a Fifth Generation New Radio (5G NR) signal.

10. The apparatus of claim 1, wherein the receiver further comprises:
a jammer detector configured to control the switching device based on detecting an out-of-band jammer in the received RF signal; and
a coupler configured to produce a sample of the received RF signal, wherein the jammer detector is configured to control the switching device based on the sampled received RF signal.

11. The apparatus of claim 1, wherein the receiver further comprises:
a jammer detector configured to control the switching device based on detecting an out-of-band jammer in the received RF signal; and
a low noise amplifier (LNA) configured to amplify the received RF signal, wherein the jammer detector is configured to control the switching device based on a signal-to-noise ratio (SNR) associated with the amplified received RF signal.

12. The apparatus of claim 1, further comprising:
a jammer detector configured to control the switching device based on detecting an out-of-band jammer in the received RF signal;
a low noise amplifier (LNA) configured to amplify the received RF signal; and
a coupler configured to produce a sample of the amplified received RF signal, wherein the jammer detector is configured to control the switching device based on the sampled amplified received RF signal.

13. The apparatus of claim 1, wherein the control circuit includes a look-up-table (LUT) including information regarding different concurrent signal transmission and reception profiles, wherein the control circuit is configured to control the switching device based on the information related to the scheduled concurrent transmission of the transmit RF signal and the reception of the received RF signal accessed from the LUT.

14. The apparatus of claim 13, wherein the receiver further comprises a jammer detector configured to control the switching device based on detecting an out-of-band jammer in the received RF signal.

15. The apparatus of claim 14, wherein the control circuit is configured to:
suspend controlling the switching device during one or more other concurrent transmissions of transmit RF signals and receptions of received RF signals; and
modify the LUT based on the jammer detector controlling the switching device during the one or more other concurrent transmissions of transmit RF signals and receptions of received RF signals.

16. The apparatus of claim 1, further comprising a modem including the control circuit.

17. The apparatus of claim 1, further comprising an application processor including the control circuit.

18. The apparatus of claim 1, further comprising:
a first modem configured to control the reception of the received RF signal in accordance with a first protocol;
a second modem configured to control the transmission of the transmit RF signal in accordance with a second protocol; and
a communication link coupling the first modem with the second modem, wherein the first or second modem includes the control circuit, and wherein the control circuit is configured to control the switching device based on information communicated between the first and second modems via the communication link.

19. The apparatus of claim 18, wherein the first or second protocol includes a wireless wide area network (WWAN) protocol, and the second or first protocol includes a wireless local area network (WLAN) protocol, respectively.

20. The apparatus of claim 1, further comprising:
at least one antenna;
an antenna interface, wherein the receiver is configured to receive the received RF signal via the at least one antenna and the antenna interface, wherein the receiver further comprises:
a low noise amplifier (LNA) configured to amplify the received RF signal;
one or more downconverting stages configured to frequency downconvert the received RF signal into a received analog baseband signal; and
an analog-to-digital converter (ADC) configured to convert the received analog baseband signal into a received digital baseband signal;
wherein the transmitter comprises:
a digital-to-analog converter (DAC) configured to convert a transmit digital baseband signal into a transmit analog baseband signal;
one or more upconverting stages configured to frequency upconvert the transmit analog baseband signal into an RF signal;
a power amplifier (PA) and a second filter configured to respectively amplify and filter the RF signal to generate the transmit RF signal for wireless transmission via the antenna interface and the at least one antenna; and
a modem configured to:
process the received digital baseband signal; and
generate the transmit digital baseband signal.

21. The apparatus of claim 1, wherein the first filter comprises a radio frequency (RF) filter.

22. A method, comprising:
scheduling a transmission of a transmit radio frequency (RF) signal concurrently with a reception of a received RF signal; and
enabling or bypassing a filtering of the received RF signal during the concurrent transmission and reception of the transmit and received RF signals based on at least a characteristic of the transmit RF signal.

23. The method of claim 22, wherein the characteristic of the transmit RF signal comprises a frequency of the transmit RF signal.

24. The method of claim 22, wherein the characteristic of the transmit RF signal comprises a channel by which the transmit RF signal is transmitted.

25. The method of claim 22, wherein the characteristic of the transmit RF signal comprises a power level of the transmit RF signal.

26. The method of claim 22, wherein the filtering or bypassing the filtering of the received RF signal is further based on a characteristic of the received RF signal.

27. An apparatus, comprising:
means for scheduling a transmission of a transmit radio frequency (RF) signal concurrently with a reception of a received RF signal; and
means for enabling or bypassing a filtering of the received RF signal during the concurrent transmission and reception of the transmit and received RF signals based on at least a characteristic of the transmit RF signal.

28. The apparatus of claim 27, wherein the characteristic of the transmit RF signal comprises a frequency of the transmit RF signal.

29. The apparatus of claim 27, wherein the characteristic of the transmit RF signal comprises a channel by which the transmit RF signal is transmitted and/or a power level of the transmit RF signal.

30. The apparatus of claim 27, wherein the means for enabling or bypassing the filtering of the received RF signal comprises means for enabling or bypassing the filtering of the received RF signal based on a characteristic of the received RF signal.
